(19) United States
(12) Patent Application Publication
(10) Pub. No.: US 2026/0032441 A1
(43) Pub. Date: Jan. 29, 2026

(54) WIRELESS COMMUNICATION SYSTEM, WIRELESS COMMUNICATION DEVICE, AND METHOD

(71) Applicant: KABUSHIKI KAISHA TOSHIBA, Tokyo (JP)

(72) Inventor: Masaki MUKAMOTO, Kawasaki (JP)

(73) Assignee: KABUSHIKI KAISHA TOSHIBA, Tokyo (JP)

(21) Appl. No.: 19/277,723

(22) Filed: Jul. 23, 2025

(30) Foreign Application Priority Data
Jul. 25, 2024 (JP) 2024-119629

(51) Int. Cl. H04W 12/08; H04W 12/69; H04W 84/18

(52) U.S. Cl. CPC H04W 12/08; H04W 12/69; H04W 84/18

(57) ABSTRACT

According to one embodiment, a wireless communication system includes a plurality of wireless communication devices. A first wireless communication device is configured to request a second wireless communication device to perform proxy of authentication of a third wireless communication device to be allowed to newly join a wireless multi-hop network. The second wireless communication device is configured to perform authentication communication with the third wireless communication device for performing authentication of the third wireless communication device. During the authentication communication, the first wireless communication device and the second wireless communication device are configured not to perform communication related to the authentication.

### CROSS-REFERENCE TO RELATED APPLICATIONS

This application is based upon and claims the benefit of priority from Japanese Patent Application No. 2024-119629, filed Jul. 25, 2024, the entire contents of which are incorporated herein by reference.

### FIELD

Embodiments described herein relate generally to a wireless communication system, a wireless communication device, and a method therefor.

### BACKGROUND

In recent years, it is known that wireless multi-hop networks are constructed for applications such as sensing over a wide area and communications are performed via the wireless multi-hop networks (multi-hop communications). Note that the multi-hop communication is a communication method that realizes long-distance communication by transferring data (packets) in a bucket relay manner through multiple nodes (wireless communication devices) that constitute a wireless multi-hop network. The multi-hop communication has advantages in terms of network construction costs (installation costs of each node) and scalability.

Here, it is possible to expand the scale of a wireless multi-hop network by adding newly joined nodes thereto (that is, adding newly joined nodes to the wireless multi-hop network), but in order to operate the wireless multi-hop network appropriately, it is necessary to authenticate these newly joined nodes.

However, as the scale of the wireless multi-hop network becomes large, the load for authenticating newly joined nodes becomes significantly heavy.

### BRIEF DESCRIPTION OF THE DRAWINGS

FIG. 1 is a diagram showing an example of a network configuration of a wireless communication system according to the first embodiment.

FIG. 2 is a diagram showing an application example of a wireless multi-hop network.

FIG. 3 is a diagram showing an example of the functional configuration of a wireless communication device operating as a provisioner.

FIG. 4 is a diagram showing an example of the functional configuration of a wireless communication device operating as an agent.

FIG. 5 is a diagram showing an example of the hardware configuration of the wireless communication device.

FIG. 6 is a sequence chart showing an example of a processing procedure for allowing newly joined nodes to join a wireless multi-hop network.

FIG. 7 is a sequence chart showing an example of a processing procedure for allowing newly joined nodes to join a wireless multi-hop network in the second embodiment.

### DETAILED DESCRIPTION

In general, according to one embodiment, a wireless communication system includes a plurality of wireless communication devices that constitute a wireless multi-hop network. A first wireless communication device that operates to manage the wireless multi-hop network among the plurality of wireless communication devices is configured to request a second wireless communication device, that is different from the first wireless communication device, to perform proxy of authentication of a third wireless communication device to be allowed to newly join the wireless multi-hop network. The second wireless communication device is configured to perform authentication communication with the third wireless communication device for performing authentication of the third wireless communication device. During the authentication communication, the first wireless communication device and the second wireless communication device are configured not to perform communication related to the authentication.

Various embodiments will be described with reference to the accompanying drawings.

### First Embodiment

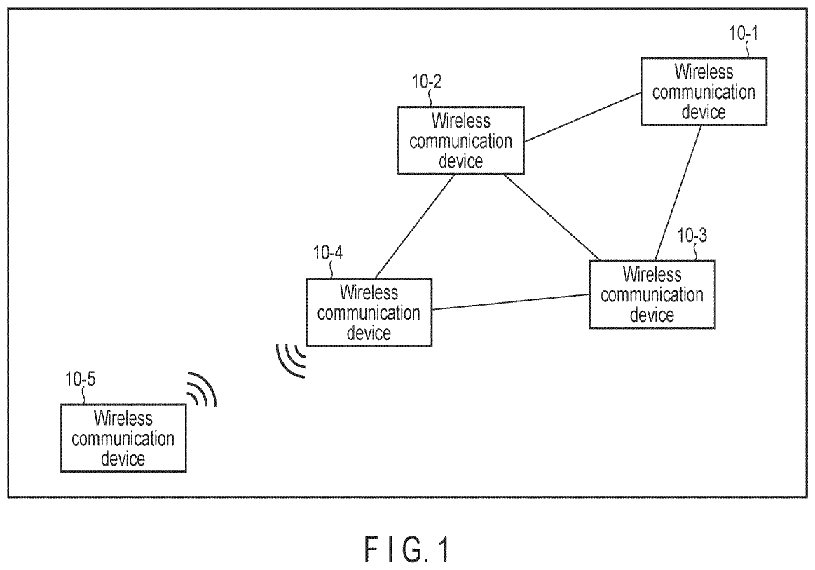

First, the first embodiment will be described. FIG. 1 shows an example of a network configuration of a wireless communication system according to this embodiment. In FIG. 1, wireless communication devices 10-1 to 10-4 provided in the wireless communication system are shown. Each of the wireless communication devices 10-1 to 10-4 is configured to be able to perform, for example, short-range wireless communications.

In this embodiment, short-range wireless communications include wireless communications based on Bluetooth Low Energy (registered trademark) (hereinafter referred to as “BLE”). In this case, the wireless communication devices 10-1 to 10-4 are realized by various electronic devices (devices equipped with BLE functionality), such as IoT (Internet of Things) devices or smartphones, that are capable of performing wireless communication based on BLE.

Here, BLE has a function to form a wireless multi-hop network called Bluetooth (registered trademark) Mesh, and each of the wireless communication devices 10-1 to 10-4 shown in FIG. 1 operates as a node which constitutes the wireless multi-hop network (Bluetooth Mesh network) formed by the Bluetooth Mesh.

In the above-described wireless multi-hop network, for example, data transmitted from the wireless communication device 10-1 is relayed by the wireless communication device 10-2 or 10-3, and the data relayed by the wireless communication device 10-2 or 10-3 is received by the wireless communication device 10-4, thereby enabling multi-hop communication. With this configuration, for example, the wireless communication device 10-1 can realize the communication (sending and receiving of data) with the wireless communication device 10-4, which is beyond the communication range based on the BLE of the wireless communication device 10-1.

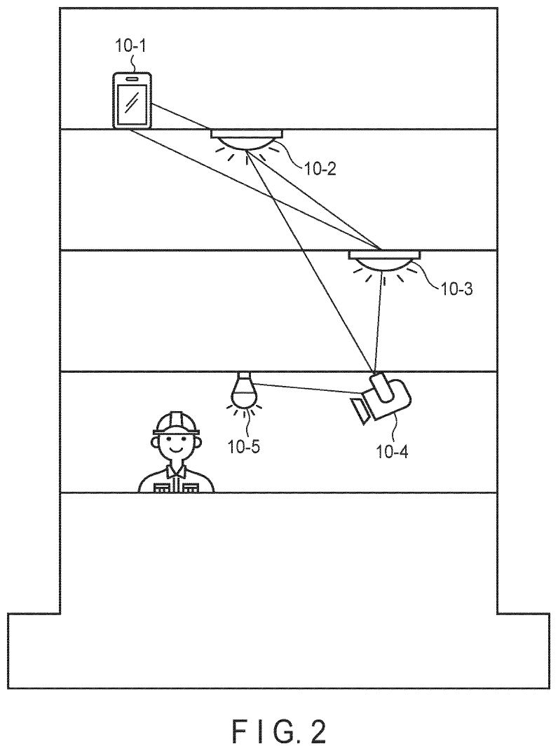

Note that FIG. 2 shows an example of the application of the wireless multi-hop network in this embodiment. In FIG. 2, it is assumed that a wireless multi-hop network is applied in a construction such as a building consisting of multiple floors.

In the example shown in FIG. 2, the wireless communication device 10-1 is a smartphone used by a manager or the like of the building, the wireless communication devices 10-2 and 10-3 are lighting fixtures (lighting devices equipped with BLE functionality) installed on each floor of the building, and the wireless communication device 10-4 is a camera installed on a floor, which is different from the floors where the wireless communication devices 10-2 and 10-3 are installed.

With this configuration, even when the wireless communication device 10-1 is located remotely from the wireless communication device 10-4, the wireless communication device 10-1 can perform communications with the wireless communication device 10-4 (sending of various data) via the wireless communication devices 10-2 or 10-3 located within the building.

Here, it is assumed that data transmitted from the wireless communication device 10-1 is received by the wireless communication device 10-4. The wireless communication device 10-1, which is the transmission source of the data, is referred to as a transmitting node, and the wireless communication device 10-4, which is the destination of the data, is referred to as a receiving node. Further, the wireless communication devices 10-2 and 10-3 that relay the data transmitted from the wireless communication device 10-1 (transmitting node) to the wireless communication device 10-4 (receiving node) are referred to as relay nodes.

In this embodiment, the wireless communication devices 10-1 to 10-4 that constitute the wireless multi-hop network can each operate as a transmitting node, a receiving node, or a relaying node. Specifically, for example, when the wireless communication device 10-3 operates as a transmitting node and the wireless communication device 10-1 operates as a receiving node, the wireless communication devices 10-2 and 10-4 may operate as relaying nodes. Further, at least one of the multiple wireless communication devices 10-1 to 10-4 may be a wireless communication device that operates solely as a relaying node.

Note that the Bluetooth Mesh described above achieves highly reliable multi-hop communication by flooding communication. In flooding communication, each node which constitutes a wireless multi-hop network operates to transfer data to all nodes within its communication range when performing multi-hop communication. In such flooding communication, there is no need to select a specific path for multi-hop communication, which simplifies network management and allows communication to continue without significant disruption even if communication is interrupted between some nodes within the network.

In the above-described flooding communication, all nodes that constitute the wireless multi-hop network are involved in data transfer (transmission). Therefore, from the perspective of operating the wireless multi-hop network appropriately, it is important to keep track of the nodes that constitute (are participating in) the wireless multi-hop network.

In Bluetooth Mesh, by authenticating newly joined nodes that are newly joined to the wireless multi-hop network in accordance with provisioning (, which will be hereinafter referred to as “newly joined nodes”), it is possible to identify the nodes that constitute the wireless multi-hop network. Note that the term “provisioning” refers to the procedure for adding newly joined nodes (wireless communication devices) to a wireless multi-hop network.

In this case, among the multiple nodes that constitute the wireless multi-hop network, there are network management nodes called provisioners, and it is of a generation operation that the provisioners take the lead in authenticating newly joined nodes.

In order to authenticate newly joined nodes, the provisioner needs to perform BLE-based wireless communication with the newly joined nodes. However, the BLE-based wireless communication is short-range wireless communication, and when authenticating newly joined nodes, the provisioner must necessarily approach the newly joined nodes to a distance where such short-range wireless communication can be carried out. The distance at which the BLE-based wireless communication can be carried out is, for example, approximately ten some meters, and in cases where the network is scaled up by leveraging the advantages of wireless multi-hop networks, the load for authenticating newly joined nodes increases. Specifically, in a large-scale wireless multi-hop network where numerous newly joined nodes are each located at distant locations, the owner of the provisioner must move the provisioner to the vicinity of each newly joined node to authenticate the newly joined node (that is, execute the provisioning process), and such an operation requires heavy labor.

Therefore, in this embodiment, such a configuration will be explained that authentication of newly joined nodes from a remote location is realized by having nodes (wireless communication devices) other than the provisioner perform authentication of newly joined nodes.

In the following explanation, nodes other than the provisioner that perform authentication of newly joined nodes are referred to as agents (authentication proxy nodes).

To explain with reference to FIGS. 1 and 2, for example, when it is assumed that the wireless communication device 10-1 is the provisioner, the wireless communication device 10-5 is a newly joined node, and the wireless communication device 10-5 is not located within the communication range of the wireless communication device 10-1 based on BLE, the wireless communication device 10-4, which is located near the wireless communication device 10-5, operates as an agent and performs proxy of authentication of the wireless communication device 10-5. With this configuration, the authentication of the newly joined node can be performed without moving the provisioner near the newly joined node (that is, the newly joined node can be joined to the wireless multi-hop network).

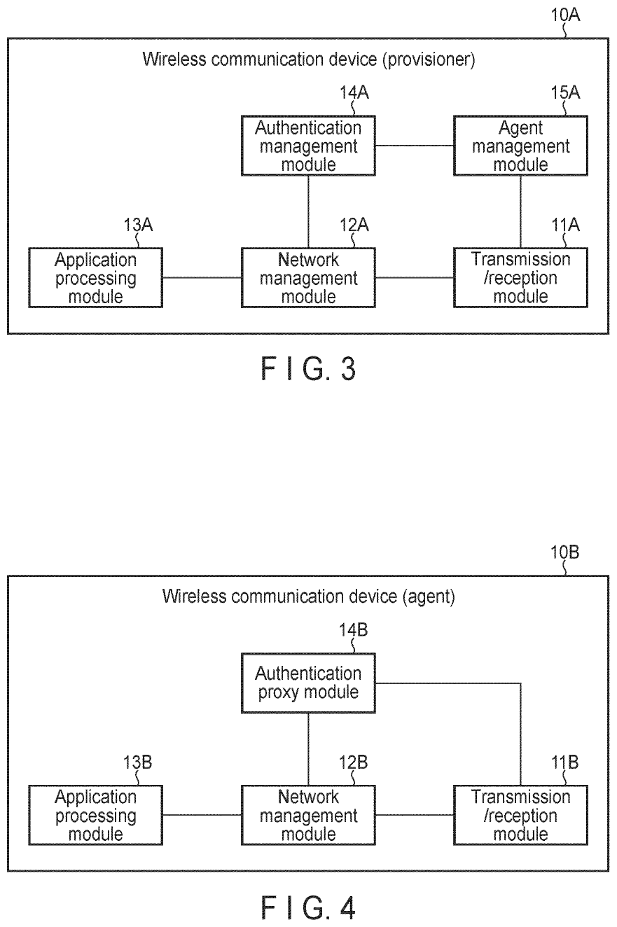

A functional configuration of the wireless communication device according to this embodiment will now be described. FIG. 3 shows an example of the functional configuration of a wireless communication device (hereinafter referred to simply as a “provisioner”) that operates as a provisioner among multiple wireless communication devices that constitute a wireless multi-hop network. A provisioner 10A shown in FIG. 3 (for example, the wireless communication device 10-1 shown in FIGS. 1 and 2) operates to manage the network in a Bluetooth Mesh and can operate as well in a manner similar to that of other nodes that constitute a conventional wireless multi-hop network.

As shown in FIG. 3, the provisioner 10A includes a transmission/reception module 11A, a network management module 12A, an application processing module 13A, an authentication management module 14A, and an agent management module 15A.

The transmission/reception module 11A performs data transmission and reception with other nodes via an antenna mounted on the provisioner 10A, for example.

The network management module 12A manages information necessary for performing multi-hop communication (communication via a wireless multi-hop network). Note that the information necessary for performing multi-hop communication includes, for example, the network key (Network Key) used for the multi-hop communication and the unicast addresses assigned to each node constituting the wireless multi-hop network. Further, the network management module 12A executes, for example, processing regarding encryption and decryption using the network key, and processing for transferring data to other nodes in multi-hop communication.

Here, the wireless multi-hop network in this embodiment can be used to provide services realized by various applications. The application processing module 13A manages application keys corresponding respectively to the various applications described above.

Further, as described above, the provisioner 10A can operate in a manner similar to that of other nodes (that is, conventional Bluetooth Mesh network nodes) that constitute the wireless multi-hop network, whereas the application processing module 13A executes processing based on the application applicable to the application processing module 13A (provisioner 10A). The processing based on the application includes, for example, generating data corresponding to the application (application data).

The authentication management module 14A handles authentication procedures for newly joined nodes and executes processing related to the authentication of the newly joined nodes. Specifically, the authentication management module 14A executes the processing of issuing unicast addresses assigned to nodes constituting the wireless multi-hop network.

The agent management module 15A manages agents that perform proxy of authentication of newly joined nodes. Note that the agent management module 15A performs the processing of, such as requesting agents to perform proxy of authentication of newly joined nodes when such nodes are deployed.

FIG. 4 shows an example of the functional configuration of a wireless communication device (hereinafter referred to simply as an agent) that operates as an agent among multiple wireless communication devices that constitute a wireless multi-hop network. An agent 10B shown in FIG. 4 (that is, the wireless communication device 10-4 shown in FIGS. 1 and 2) normally operates in a manner similar to that of other nodes that constitute the wireless multi-hop network, and operates as an agent in response to a request from the provisioner.

As shown in FIG. 4, the agent 10B includes a transmission/reception module 11B, a network management module 12B, an application processing module 13B, and an authentication proxy module 14B.

The transmission/reception module 11B performs transmission and reception of data with other nodes via the antenna mounted on the agent 10B, for example.

The network management module 12B manages information necessary for performing multi-hop communication. Note that in the network management module 12A shown in the above FIG. 3 (that is, the provisioner 10A), the unicast addresses of all nodes constituting the wireless multi-hop network are managed, but the network management module 12B does not need to manage all of these unicast addresses, but it is sufficient to manage the unicast address of the agent 10B. Further, the information necessary for performing multi-hop communication managed by the network management module 12B contains the network key described above. Furthermore, the network management module 12B executes, for example, the processing relating to encryption and decryption using the network key, the processing of transferring data to other nodes in multi-hop communication and the like.

The application processing module 13B manages application keys corresponding to applications to be applied to the agent 10B. Further, the application processing module 13B executes processing based on applications to be applied to the agent 10B.

The authentication proxy module 14B performs proxy of authentication of newly joined nodes on behalf of the provisioner 10A in response to a request from the provisioner 10A described above (that is, on behalf of the provisioner 10A).

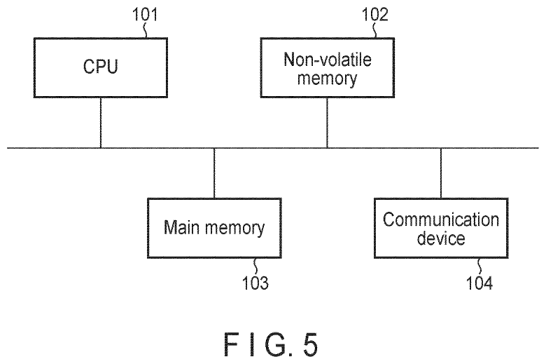

FIG. 5 shows an example of the hardware configuration of nodes (wireless communication devices) that constitute a wireless multi-hop network. Note that in FIG. 5, the hardware configuration of a single node is described, but the hardware configuration is similar in the case where the node is a provisioner 10A or an agent 10B.

As shown in FIG. 5, the nodes that constitute a wireless multi-hop network include a CPU 101, a non-volatile memory 102, a main memory 103, a communication device 104 and the like.

The CPU 101 is a processor that controls the operation of each component within the node. The CPU 101 executes various programs loaded from the non-volatile memory 102, which is a storage device, to the main memory 103. The communication device 104 is configured to execute wireless communication based on the BLE described above.

Note that although omitted in FIG. 5, when the node (for example, provisioner 10A) is implemented by a smartphone, the node may further include a touchscreen display in which an input device and a display device are configured to be integrated as one body, or the like.

Moreover, let us now assume that the provisioner 10A shown in FIG. 3 has the hardware configuration shown in FIG. 5. Then, some or all of the components 11A to 15A shown in FIG. 3 may be realized by making the CPU 101 shown in FIG. 5 execute a predetermined program, that is, software. Note here that some or all of the components 11A to 15A shown in FIG. 3 may be realized by hardware such as integrated circuits (ICs), or by a combination of software and hardware.

Furthermore, let us now assume that the agent 10B shown in FIG. 4 has the hardware configuration shown in FIG. 5. Then, some or all of the components 11B to 14B shown in FIG. 4 may be realized by making the CPU 101 shown in FIG. 5 execute a predetermined program, that is, by software. Note here that some or all of the components 11B to 14B shown in FIG. 4 may be implemented by hardware or by a configuration of a combination of software and hardware.

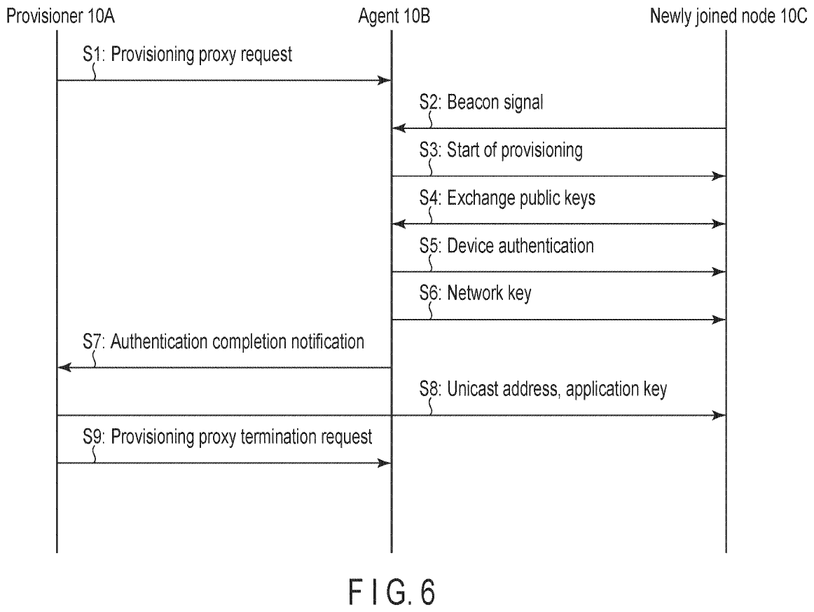

With reference to the sequence chart in FIG. 6, an example of the processing procedure at the time when a newly joined node is added to a wireless multi-hop network in this embodiment will be described. In FIG. 6, the operations of the provisioner 10A, the agent 10B, and a newly joined node 10C are shown.

First, in the present embodiment, multiple nodes that constitute the wireless multi-hop network (Bluetooth Mesh network) are placed at various positions within the space (space where multi-hop communication is performed) where the wireless multi-hop network is formed. When adding a newly joined node 10C to such a wireless multi-hop network, for example, the owner of the newly joined node 10C places (installs) the newly joined node 10C at a predetermined location within the space where the wireless multi-hop network is formed.

The agent management module 15A included in the provisioner 10A determines nodes that are located within a range within which it can perform communication (short-range wireless communication) with the newly joined node 10C based on the BLE as agents 10B.

Note here that when the provisioner 10A manages the location (position) of each of the nodes constituting the wireless multi-hop network, the agent management module 15A can determine nodes whose distance from the position where the newly joined node 10C is placed is a predetermined value or less (that is, nodes which are located within a predetermined range from the newly joined node 10C) as the agents 10B based on the position of each of the nodes. Incidentally, for example, it suffices if the location where the newly joined node 10C is placed is notified from the owner of the newly joined node 10C to the owner of the provisioner 10A and entered in advance to the provisioner 10A by the owner of the provisioner 10A. Further, the node determined as the agent 10B may be directly specified by the owner of the provisioner 10A.

When the agent 10B is determined as described above, the agent management module 15A issues a provisioning proxy request requesting the authentication (that is, provisioning) of the newly joined node 10C, and transmits the issued provisioning proxy request to the agent 10B via the transmission/reception module 11A (step S1). It is assumed here that the provisioning proxy request contains information necessary for provisioning (hereinafter referred to as provisioning information) written therein. The provisioning information may contain, for example, device information related to the newly joined node 10C.

Since the agent 10B is a node that constitutes a wireless multi-hop network (that is, an already authenticated node), the above-described provisioning proxy request can be transmitted from the provisioner 10A to the agent 10B via the wireless multi-hop network (that is, by multi-hop communication).

When the processing of step S1 is executed, the transmission/reception module 11B included in the agent 10B receives the provisioning proxy request transmitted from the provisioner 10A. When the provisioning proxy request is received by the transmission/reception module 11B, the agent 10B operates to proxy the authentication of the newly joined node 10C. In this case, the authentication proxy module 14B carries out proxy of the authentication communication (communication for carrying out the authentication of the newly joined node 10C) and starts scanning for beacon signals via the transmission/reception module 11B.

Here, when the newly joined node 10C is placed within the space where the wireless multi-hop network is formed as described above, and the power of the newly joined node 10C is turned on, it operates to periodically transmit a beacon signal (perform beacon advertising) (step S2).

When a beacon signal is transmitted from the newly joined node 10C after the scanning of beacon signals by the authentication proxy module 14B has started as described above, the transmission/reception module 11B included in the agent 10B receives the beacon signal.

Note that the above-described step S1 is explained on the assumption that a provisioning proxy request is transmitted to a single node determined as the agent 10B, but this provisioning proxy request may as well be transmitted to multiple nodes. In this case, it suffices if among the multiple nodes that have received the provisioning proxy request, those nodes which have been able to receive the beacon signal transmitted from the newly joined node 10C can act as the agents 10B.

When the beacon signal is received by the transmission/reception module 11B, the authentication proxy module 14B notifies the newly joined node 10C of the start of provisioning (step S3).

Note that the communication between the agent 10B and the newly joined node 10C, including the processing of steps S2 and S3 described above, is wireless communication based on the BLE (Bluetooth communication). This is also the case for the communication between the agent 10B and the newly joined node 10C, which will be described below.

Next, the agent 10B and the newly joined node 10C exchange public keys to be used for encrypting communications carried out between the agent 10B and the newly joined node 10C (step S4). In step S4, the public key of the agent 10B is transmitted from the agent 10B to the newly joined node 10C, and the public key of the newly joined node 10C is transmitted from the newly joined node 10C to the agent 10B. Note that the public key is a key that is paired with a private key generated based on a public key cryptosystem, and the private key of the agent 10B is managed within the agent 10B, while the private key of the newly joined node 10C is managed within the newly joined node 10C. With this configuration, data encrypted using the public key of the agent 10B at the newly joined node 10C, for example, can be decrypted at the agent 10B using the private key of the agent 10B. Similarly, for example, data encrypted using the public key of the newly joined node 10C at the agent 10B can be decrypted at the newly joined node 10C using the private key of the newly joined node 10C. With this configuration, T the security of communication between the agent 10B and the newly joined node 10C can be improved.

When the processing of step S4 is executed, the authentication proxy module 14B included in the agent 10B performs device authentication for the newly joined node 10C (step S5).

The device authentication performed in step S5 will now be described. In Bluetooth Mesh, the device authentication is performed according to one of three authentication methods: input authentication, output authentication, and static authentication.

The input authentication is an authentication method based on the input to the newly joined node 10C, for example. Specifically, in the input authentication, for example, when the owner of the newly joined node 10C performs an operation of pressing down a button provided on the newly joined node 10C, the newly joined node 10C operates to notify (transmit) the number of times the button was pressed to the agent 10B. Then, when it is confirmed at the agent 10B that the number of times matches the number specified by the instruction made in advance, the authentication of the newly joined node 10C is successful.

The output authentication is an authentication method performed based on the output from the newly joined node 10C. Specifically, in the output authentication, for example, the newly joined node 10C performs an operation to light an LED installed in the newly joined node 10C. Then, when it is confirmed at the agent 10B that the operation (the color and number of times the LED is lit) matches the instructions made in advance, the authentication of the newly joined node 10C is successful.

Note that in the above-described input authentication and output authentication, the newly joined node 10C is made to perform a predetermined action, thereby authenticating the newly joined node 10C (that is, identifying the newly joined node 10C). On the other hand, the static authentication is performed solely based on information possessed by the agent 10B without, for example, any special actions performed by the newly joined node 10C. Here, the provisioning proxy request transmitted from the provisioner 10A to the agent 10B in the step S1 described above includes provisioning information written thereon. Note that it is assumed that the provisioning information contain the MAC address of the newly joined node 10C as device information regarding the newly joined node 10C that is known in advance by the owner of the provisioner 10A. In this case, in the static authentication, the MAC address extracted from the provisioning information written in the provisioning proxy request is compared with the MAC address transmitted from the newly joined node 10C during communication with the newly joined node 10C, and when it is confirmed that these MAC addresses match each other, the authentication of the newly joined node 10C is successful.

In this embodiment, the device authentication is performed according to the authentication method selected by the agent 10B from among the above-described multiple authentication methods (for example, input authentication, output authentication, and static authentication).

Note that in this embodiment, the agent 10B is required to select the authentication method, but the selected authentication method may be specified, for example, by the provisioner 10A in the provisioning information written in the provisioning proxy request. Further, the provisioner 10A may specify an authentication method randomly selected from the above-described multiple authentication methods, or specify a predetermined authentication method, or specify an authentication method in accordance with the instructions of the owner of the provisioner 10A.

When the authentication of the newly joined node 10C is successful in the device authentication performed in step S5, the newly joined node 10C can join the wireless multi-hop network. However, in the wireless multi-hop network, a common key (a key based on a common key cryptosystem) called a network key is used to encrypt network PDUs (Protocol Data Units), which are transmission and reception units of data (packets). Therefore, each node in the wireless multi-hop network becomes able to transmit and receive data in the multi-hop communication by obtaining this network key. For this reason, the network management module 12B included in the agent 10B accesses the network key managed by the network management module 12B (that is, the network key possessed by the agent 10B) and gives (transmits) the network key to the newly joined node 10C via the transmission/reception module 11B (step S6).

Note here that all nodes that constitute the wireless multi-hop network hold the same network key, and therefore in this embodiment, by passing the network key possessed by the agent 10B to the newly joined node 10C, the newly joined node 10C is enabled to perform the multi-hop communication.

When the processing of step S6 is executed, the authentication proxy module 14B included in the agent 10B transmits an authentication completion notification to the provisioner 10A via the transmission/reception module 11B to report the completion of authentication of the newly joined node 10C (step S7). The authentication completion notification transmitted in step S7 includes, for example, identification information for identifying the newly joined node 10C (that is, the authenticated node).

The interactions between the agent 10B and newly joined node 10C corresponding to the processing of steps S2 to S6 described above correspond to authentication communication, which is generally performed between the provisioner 10A and the newly joined node 10C. Here, note that this authentication communication is not a particularly load-intensive process (task) and does not use information possessed only by the provisioner 10A. Therefore, in this embodiment, authentication communication with the newly joined node 10C is performed between the agent 10B and the newly joined node 10C, and while the authentication communication is being performed, the provisioner 10A does not need to perform communication with the newly joined node 10C. That is, in this embodiment, only the above-described provisioning proxy request and authentication completion notification are transmitted over the wireless multi-hop network, and all other information is exchanged solely between the agent 10B and the newly joined node 10C.

Here, it is possible to decrypt data (network PDUs encrypted using the network key) transmitted in multi-hop communication based on the network key assigned in the above-described step S7, but there may be cases where the newly joined node 10C requires information not possessed by the agent 10B in order to perform the multi-hop communication. Therefore, the newly joined node 10C obtains such information not possessed by the agent 10B from the provisioner 10A.

Note that, as described above, the newly joined node 10C possesses the network key, multi-hop communication can be performed between the provisioner 10A and the newly joined node 10C.

First, the authentication management module 14A included in the provisioner 10A assigns (issues) a unicast address based on the authentication completion notification transmitted in the above-described step S7. Note that the unicast address is a unique address information within the wireless multi-hop network, and it is desirable that the provisioner 10A, which keeps track of all nodes within the network, issue it in order to maintain uniqueness. Therefore, the unicast address is provided to the newly joined node 10C from the provisioner 10A. Thus, the unicast address issued by the authentication management module 14A is assigned to the newly joined node 10C and managed by the network management module 12A.

Further, in this embodiment, there are cases where data corresponding to application programs (application data) is transmitted and received via a wireless multi-hop network. To perform such transmission and reception of application data (hereinafter referred to as application communication), it is necessary to possess an application key (Application Key). The application key is, for example, a common key prepared for the application applied to each node. That is, since the agent 10B does not possess the application key corresponding to the application that is not applied to the agent 10B (that is, the agent 10B is not involved), the application key is provided to the newly joined node 10C from the provisioner 10A.

Note that the application key is used to protect the application data, and the network key described above is used to protect the entire packet. Therefore, in the multi-hop communication, network information and the like are provided to application data encrypted with the application key, and the data which is encrypted with the network key is transmitted and received with respect to the data in its entirely.

The network management module 12A provides (transmits) the unicast address and application key described above to the newly joined node 10C as information necessary for the newly joined node 10C to perform multi-hop communication, via the transmission/reception module 11A (step S8).

When the processing of step S8 is executed and it is confirmed that the newly joined node 10C has joined the wireless multi-hop network (that is, it is now in a state of being capable of performing multi-hop communication), the agent management module 15A included in the provisioner 10A issues a provisioning proxy termination request which requests the termination of proxy of the provisioning (authentication of the newly joined node 10C), and transmits the thus issued provisioning proxy termination request to the agent 10B via the transmission/reception module 11A (step S9).

When the processing of step S9 is executed, the processing carried out for joining the newly joined node 10C to the wireless multi-hop network shown in FIG. 6 is completed.

As described above, in this embodiment, the provisioner 10A (first wireless communication device) that operates to manage the wireless multi-hop network requests the agent 10B (second wireless communication device), which is different from that of the provisioner 10A, to perform proxy of authentication the newly joining node 10C (third wireless communication device) that is to be newly joined to the wireless multi-hop network. Further, in this embodiment, the agent 10B performs authentication communication with the newly joined node 10C for the purpose of authenticating the newly joined node 10C. Note that in this embodiment, during the authentication communication is being performed, the provisioner 10A and the agent 10B do not, in principle, perform any communication related to the authentication. But, even during the authentication communication, the provisioner 10A and the agent 10B can perform communication as a wireless multi-hop network, and in some cases, a proxy termination request may be transmitted or received during the authentication.

In this embodiment, the provisioner 10A, the agent 10B, and the newly joined node 10C (acting as wireless communication devices) are configured to perform wireless communication based on BLE (Bluetooth communication), and the wireless multi-hop network is assumed to be a network formed by Bluetooth Mesh. Further, it is assumed that the provisioner 10A is located at a distance where BLE-based wireless communication cannot be performed with the newly joined node 10C (that is, at a remote location relative to the newly joined node 10C), and the agent 10B is located at a distance where BLE-based wireless communication can be performed with the newly joined node 10C (that is, at a nearby location relative to the newly joined node 10C). Furthermore, the agent 10B is determined (selected) from among multiple nodes that constitute a wireless multi-hop network based on the location of the newly joined node 10C.

In this embodiment, with the above-described configuration, it is possible to reduce the load of authenticating nodes (wireless communication devices) newly joining the wireless multi-hop network.

Here, let us assume a wireless communication system in which the provisioner 10A primarily performs the authentication of the newly joined node 10C (, which will be hereinafter referred to as the first comparative example of the present embodiment). In the case of the first comparative example of the present embodiment, when the wireless multi-hop network is of a large scale, it is necessary to move the provisioner 10A to a location within the range where BLE-based wireless communication can be performed with the newly joined node 10C each time the authentication of the newly joined node 10C is performed, and thus the load for performing the authentication of the newly joined node 10C is large.

Further, let us consider a wireless communication system in which, for example, a single node which can perform direct communication (Bluetooth communication) with the newly joined node 10C is simply designated as an authentication proxy node, and the provisioner performs authentication of the newly joined node 10C via the authentication proxy node (, which will be hereinafter referred to as the second comparative example of the present embodiment). In the case of the second comparative example of the present embodiment, the provisioner 10A can perform authentication of the newly joined node 10C from a remote distance, but the authentication proxy node merely relays the authentication communication, and the information required for authentication is transmitted and received between the provisioner 10A and the newly joined node 10C via the wireless multi-hop network. The wireless multi-hop network in this embodiment is formed using Bluetooth Mesh. Here, in consideration of its low throughput, as to the second comparative example of this embodiment, there is a possibility that other application communications executed via the wireless multi-hop network during the authentication of the newly joined node 10C may be congested (that is, the load applied on the wireless multi-hop network may increase).

In contrast, in this embodiment, authentication communication is performed between the agent 10B, which directly performs wireless communication based on BLE, and the newly joined node 10C (that is, the agent 10B handles most of the authentication procedure). With this configuration, it is possible to realize authentication from remote distance while reducing the load applied on the wireless multi-hop network.

Note that in this embodiment, when the authentication of the newly joined node 10C is successful, the agent 10B transmits the network key used for performing multi-hop communication to the newly joined node 10C, and notifies the provisioner 10A of the completion of authentication via the wireless multi-hop network.

Further, in this embodiment, when the completion of authentication is notified from the agent 10B, the provisioner 10A transmits the address (unicast address) to be assigned to the newly joined node 10C in the wireless multi-hop network to the newly joined node 10C via the wireless multi-hop network.

From the perspective of avoiding the authentication of the newly joined node 10C from congesting with other application communications, when performing authentication of the newly joined node 10C, as described above, a configuration in which the unicast address described above as well is transmitted (assigned) from the agent 10B to the newly joined node 10C is considered (, which will be hereinafter referred to as the third comparative example of the present embodiment). However, to implement the third comparative example of the present embodiment, all nodes (all nodes which can operate as the agent 10B) which constitute the wireless multi-hop network must keep track of all unicast addresses assigned to other nodes, which complicates the management of unicast addresses at each node. In other words, in the third comparative example of the present embodiment, it may not be possible to reduce the load for performing authentication of the newly joined node 10C in some cases.

On the other hand, in the present embodiment, by configuring the provisioner 10A that keeps track of all nodes (unicast addresses) in the wireless multi-hop network to issue and assign unicast addresses to the newly joined nodes 10C, it is possible to reduce the load for performing authentication of the newly joined nodes 10C.

Here, it has been explained on the assumption that unicast addresses are assigned by the provisioner 10A, but application keys as well are assumed to be assigned by the provisioner 10A. Specifically, each node constituting the wireless multi-hop network possesses only the application key corresponding to the application applicable to that node. In such a case, for a configuration in which the agent 10B assigns the application key corresponding to the application applicable to the newly joined node 10C to the newly joined node 10C, all nodes that constitute the wireless multi-hop network (that is, all nodes that can operate as the agent 10B) must manage all application keys, and such management is complicated.

Therefore, in this embodiment, the provisioner 10A, which manages all application keys, is configured to assign the application keys.

However, when the agent 10B possesses the application key corresponding to the application applied to the newly joined node 10C (that is, the application applicable to the agent 10B and the newly joined node 10C is common), the agent 10B may assign the application key to the newly joined node 10C. Specifically, in a wireless multi-hop network where only a single application is running (that is, the same application is applied to all nodes constituting the wireless multi-hop network), the agent 10B may simply assign the application key possessed by the agent 10B itself to the newly joined node 10C. Further, when the application applicable to the newly joined node 10C is notified to the agent 10B from the newly joined node 10C, and it is determined that the agent 10B possesses the application key corresponding to the application, the application key may be assigned from the agent 10B to the newly joined node 10C. In this way, when the application key can be assigned from the agent 10B to the newly joined node 10C, there is no need to transmit and receive the application key via the wireless multi-hop network, thereby making it possible to suppress the congestion on application communication. It is assumed here that the application applicable to the newly joined node 10C may be applied for by, for example, the owner of the provisioner 10A or the owner of the newly joined node 10C or the like.

In this embodiment, the description is made in connection with the case where the unicast address and application key are assigned to the newly joined node 10C by the provisioner 10A after the authentication completion notification is transmitted from the agent 10B to the provisioner 10A. But the unicast address and application key may be provided in advance to the agent 10B by the provisioner 10A as provisioning information written in the provisioning proxy request. In such a case, as described above, after the authentication completion notification is transmitted from the agent 10B to the provisioner 10A, the agent 10B can assign the unicast address and application key to the newly joined node 10C, and therefore the communication with the provisioner 10A can be suppressed to a minimum level.

In this embodiment, when requesting the proxy of authentication of the newly joined node 10C, the provisioner 10A may transmit device information (static information of the newly joined node 10C) related to the newly joined node 10C to the agent 10B. In this case, it is assumed that the device information related to the newly joined node 10C is included in the provisioning information written in the provisioning proxy request. In this embodiment, by configuring to perform device authentication (authenticate the newly joined node 10C) using such device information, no operations or the like for the newly joined node 10C, for example, are necessary and therefore it is possible to reduce the work required for device authentication.

Note that in this embodiment, the descriptions is made in connection with the case where the MAC address of the newly joined node 10C is used as the device information described above, but the device information may as well be some other unique information such as the Universally Unique Identifier (UUID), the device name or the like, of the newly joined node 10C.

Further, as the device information, a password specified by the owner of the newly joined node 10C may be used. This password is informed in advance from the owner of the newly joined node 10C to the owner of the provisioner 10A, and is transmitted (transferred) from the provisioner 10A to the agent 10B using the above-described provisioning proxy request. With this configuration, when it is confirmed that the password transmitted from the newly joined node 10C to the agent 10B in device authentication matches the password transmitted from the provisioner 10A to the agent 10B, the authentication of the newly joined node 10C is successful. In this case, it is assumed that the newly joined node 10C is provided with an interface that allows the owner of the newly joined node 10C to enter the password. By performing device authentication using such a temporary password, it is possible to avoid transmission and reception of unique information such as the MAC address described above via a wireless multi-hop network (that is, propagation thereof to the wireless multi-hop network). Thus, suppression of unnecessary information propagation can be achieved.

Here, in the embodiment, the description is made in connection with the case where a provisioning proxy request is transmitted from the provisioner 10A to the agent 10B, but the provisioner 10A may, for example, in response to an operation by the owner of the provisioner 10A or the like, set the period during which the agent 10B performs the proxy of authentication of the newly joined node 10C (hereinafter referred to as the proxy period) or the conditions for terminating such proxy (hereinafter referred to as the proxy termination condition”) in the provisioning proxy request (provisioning information).

Specifically, for example, when a newly joined node 10C has already been deployed (installed) and it is ready to start authentication of the newly joined node 10C immediately, the provisioner 10A can set the proxy period described above to a short period of time, such as one hour or the like, in the provisioning proxy request. On the other hand, when a long-term operation is expected, such as deploying a large number of newly joined nodes 10C and performing authentication thereon, the provisioner 10A may set the proxy period to one day or the like in the provisioning proxy request.

When the agent 10B, by receiving a provisioning proxy request in which such a proxy period is set from the provisioner, cannot complete the authentication of the newly joined node 10C (that is, the authentication communication) before the proxy period expires, it terminates the proxy of authentication. In this case, the agent 10B may automatically terminate the proxy of authentication when the proxy period expires, or it may terminate the proxy of authentication in accordance with an authentication proxy termination notification transmitted by the provisioner 10A when the proxy period expires.

In addition, for example, when the number of newly joined nodes 10C is grasped, the provisioner 10A may set the number of nodes as the proxy termination condition in the provisioning proxy request.

The agent 10B terminates the proxy of authentication when the authentication of newly joined nodes 10C by the number set as the proxy termination condition is completed (finished). Note that the agent 10B may terminate the proxy of authentication in accordance with the authentication proxy termination notification transmitted from the provisioner 10A when the authentication of newly joined nodes 10C by the number set as the proxy termination condition is completed. The provisioner 10A can grasp the number of newly joined nodes 10C for which the authentication has been completed based on the number of authentication completion notifications (or unicast addresses issued for newly joined nodes 10C) transmitted from the agent 10B.

Note that the proxy of authentication described above may be terminated, for example, by an instruction from the owner of the provisioner 10A. Further, when performing the proxy of authentication for multiple newly joined nodes 10C, the authentication may be performed by a single agent 10B or by multiple agents 10B.

### Second Embodiment

Next, the second embodiment will be described. In the second embodiment, explanations of similar parts to those of the first embodiment will be omitted, and the parts that differ from those of the first embodiment will be mainly described.

In the first embodiment described above, the description is made in connection with the case where the provisioner assigns additional information (unicast address and application key) to the newly joined node from the provisioner in response to an authentication completion notification from the agent. Note that this embodiment is different from the first embodiment in that the additional information is inquired from the newly joined node to the provisioner.

Note that the functional configuration and hardware configuration of the wireless communication devices (provisioner and agent) in this embodiment are as those described in the first embodiment, and therefore the explanation will be made with reference to FIGS. 3 to 5.

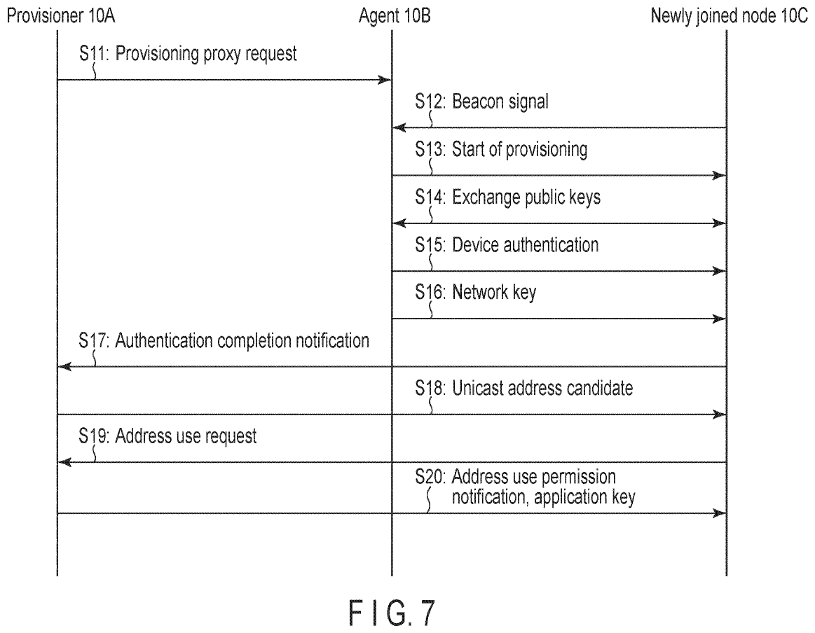

With reference to the sequence chart shown in FIG. 7, an example of the processing procedure for making a newly joined node join the wireless multi-hop network in this embodiment will be described. Note that as in the case of FIG. 6 described above, FIG. 7 shows each of the operations of the provisioner 10A, the agent 10B, and the newly joining node 10C.

First, the processing of steps S11 to S16, which corresponds to the processing of steps S1 to S6 shown in FIG. 6 described above is executed.

Note that in the first embodiment described above, the explanation is made in connection with the case where the agent 10B transmits an authentication completion notification to the provisioner 10A. On the other hand, in this embodiment, when the processing of step S16 is executed, the newly joined node 10C transmits an authentication completion notification to the provisioner 10A via the wireless multi-hop network (step S17). The processing of step S17 corresponds to a request (query) for the unicast address and application key to be assigned to the newly joined node 10C.

Note that at the time when the processing of step S17 is executed, the newly joined node 10C does not yet possess a unicast address, and therefore the transmission source address in the above-described request is set to empty information such as “0.0.0.”

When the request (authentication completion notification) from the newly joined node 10C is received by the provisioner 10A as a result of the execution of the processing of step S17, the provisioner 10A (authentication management module 14A) issues candidates for the unicast address to be assigned to the newly joined node 10C in the wireless multi-hop network, and transmits the issued candidates of the unicast address via the wireless multi-hop network (step S18). Note that here, a unicast address has not yet been assigned to the newly joined node 10C (that is, the unicast address of the newly joined node 10C has not been registered), the candidates for the unicast address are transmitted by broadcast to all nodes in the wireless multi-hop network.

Note that the candidates for the unicast address may be a single address or may be multiple addresses that can be assigned to the newly joined node 10C. Specifically, when there is only one newly joined node 10C, there is no overlapping of unicast addresses, and therefore from the viewpoint of reducing communication volume and the like, the candidate for the unicast address may be a single address. On the other hand, when there are multiple newly joined nodes 10C, overlapping of unicast addresses may occur, and therefore it is preferable that the candidates for the unicast address be multiple addresses from the viewpoint of avoiding retransmission or the like of the candidates of the unicast address.

When the candidates for the unicast address transmitted by broadcast from the provisioner 10A are received by a newly joined node 10C, the newly joined node 10C transmits an address usage request to the provisioner 10A based on the candidate for the unicast address (step S19). Note that the address usage request includes, for example, the unicast address selected by the newly joined node 10C. The unicast address included in the address usage request may be randomly selected from the candidates for the unicast address transmitted by the provisioner 10A in the step S18 described above, or may be selected (designated) by the owner of the newly joined node 10C.

When the processing of step S19 is executed, the provisioner 10A receives the address usage request transmitted from the newly joined node 10C in the step S19 and responds to the address usage request. Specifically, the provisioner 10A manages the unicast addresses assigned to each of the nodes constituting the wireless multi-hop network (hereinafter referred to as unicast addresses of other nodes) and checks whether the unicast address included in the address usage request overlaps any of the unicast addresses of other nodes.

When the unicast address included in the address usage request does not overlap with the unicast addresses of other nodes, the provisioner 10A assigns the unicast address included in the address usage request to the newly joined node 10C, and transmits a notification (address usage permission notification) indicating that the use of the unicast address is permitted, as well as the application key, to the newly joined node 10C (step S20). Note that the unicast address assigned to the newly joined node 10C is managed in the network management module 12A included in the provisioner 10A. The application key transmitted from the provisioner 10A to the newly joined node 10C in step S20 is similar to that described in the first embodiment described above, and therefore the detailed explanation is omitted here.

When the processing of step S20 described above is executed (that is, the provisioner responds to the address usage request), it becomes possible to perform multi-hop communication using the unicast address assigned to the newly joined node 10C.

Here, it is explained on the assumption that the unicast address included in the address usage request does not overlap with the unicast addresses of other nodes. But when the unicast address included in the address usage request overlaps with the unicast addresses of other nodes, a notification indicating that the use of the unicast address is refused (that is, the unicast address cannot be used) is transmitted from the provisioner 10A to the newly joined node 10C. In this case, some unicast address may be selected from the above-described candidates of unicast address at the newly joined node 10C so as to execute the processing from step S19 on, or the processing may be repeated by returning to step S18.

As described above, in this embodiment, when the completion of authentication of the newly joined node 10C is notified to the provisioner 10A from the newly joined node 10C, the unicast address to be assigned to the newly joined node 10C is transmitted from the provisioner 10A to the newly joined node 10C via the wireless multi-hop network. With such a configuration, in this embodiment, it is able to reduce the load on the agent 10B, which performs the proxy of authentication (authentication communication) of the newly joined node 10C, as compared to the first embodiment described above.

This embodiment is described on the assumption that the newly joined node 10C inquires additional information such as the unicast address and the application key from the provisioner 10A. But the unicast address (or its candidate) may be transmitted in advance from the provisioner 10A to the agent 10B as provisioning information written in the provisioning proxy request. In this case, the candidates of unicast addresses transmitted in advance from the provisioner 10A to the agent 10B are in a reserved state at the time of the transmission of the provisioning proxy request, and are formally assigned (registered) to the newly joined node 10C in the provisioner 10A at the time when the proxy of authentication is completed (that is, when the authentication completion notification is received), and are further assigned to the newly joined node 10C from the agent 10B.

According to at least one embodiment described above, it is possible to provide a wireless communication system, a wireless communication device, and a method thereof, which can reduce the load of performing authentication of a wireless communication devices newly joining a wireless multi-hop network.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A wireless communication system comprising a plurality of wireless communication devices that constitute a wireless multi-hop network,
wherein
a first wireless communication device that operates to manage the wireless multi-hop network among the plurality of wireless communication devices is configured to request a second wireless communication device, that is different from the first wireless communication device, to perform proxy of authentication of a third wireless communication device to be allowed to newly join the wireless multi-hop network,
the second wireless communication device is configured to perform authentication communication with the third wireless communication device for authenticating the third wireless communication device, and
during the authentication communication being performed, the first wireless communication device and the second wireless communication device are configured not to perform communication related to the authentication.

2. The wireless communication system of claim 1, wherein
the second wireless communication device, when the authentication of the third wireless communication device is successful, is configured to:
transmit a network key used for performing communication via the wireless multi-hop network, to the third wireless communication device, the network key being possessed by the second wireless communication device, and
notify the first wireless communication device of completion of the authentication via the wireless multi-hop network.

3. The wireless communication system of claim 2, wherein
the first wireless communication device, when the completion of the authentication is notified from the second wireless communication device, is configured to transmit an address assigned to the third wireless communication device in the wireless multi-hop network, to the third wireless communication device via the wireless multi-hop network.

4. The wireless communication system of claim 1, wherein
the second wireless communication device, when the authentication of the third wireless communication device is successful, is configured to transmit a network key used for performing communication via the wireless multi-hop network to the third wireless communication device, the network key being possessed by the second wireless communication device, and
the third wireless communication device is configured to notify the first wireless communication device of completion of the authentication via the wireless multi-hop network.

5. The wireless communication system of claim 4, wherein
the first wireless communication device, when the completion of the authentication is notified from the third wireless communication device, is configured to transmit the address assigned to the third wireless communication device in the wireless multi-hop network, to the third wireless communication device via the wireless multi-hop network.

6. The wireless communication system of claim 2, wherein
the first wireless communication device is configured to transmit an application key used for performing application communication via the wireless multi-hop network, to the third wireless communication device.

7. The wireless communication system of claim 1, wherein
the first wireless communication device, when requesting proxy of authentication of the third wireless communication device, is configured to transmit device information relating to the third wireless communication device, to the second wireless communication device, and
the second wireless communication device is configured to perform authentication of the third wireless communication device using the device information transmitted from the first wireless communication device.

8. The wireless communication system of claim 7, wherein
the device information includes a MAC address, universally unique identifier (UUID), device name, or password of the third wireless communication device.

9. The wireless communication system of claim 1, wherein
the first wireless communication device, when requesting proxy of authentication of the third wireless communication device, is configured to transmit an address assigned to the third wireless communication device in the wireless multi-hop network and an application key used for performing application communication via the wireless multi-hop network, to
the second wireless communication device, and the second wireless communication device, when the authentication of the third wireless communication device is successful, is configured to transmit a network key used for performing communication via the wireless multi-hop network, the address, and the application key, to the third wireless communication device, the network key being possessed by the second wireless communication device.

10. The wireless communication system of claim 1, wherein
the first wireless communication device, when requesting proxy of authentication of the third wireless communication device, is configured to set a period for performing the proxy or a condition for terminating the proxy, and
the second wireless communication device is configured to perform the authentication communication in accordance with the set period or condition.

11. The wireless communication system of claim 1, wherein
the first wireless communication device, when confirmed that the third wireless communication device joined the wireless multi-hop network, is configured to request the second wireless communication device to terminate the proxy of authentication of the third wireless communication device.

12. The wireless communication system of claim 1, wherein
the first to third wireless communication devices are configured to be able to perform wireless communication based on Bluetooth Low Energy (BLE), and
the wireless multi-hop network is a network formed by Bluetooth Mesh.

13. The wireless communication system of claim 12, wherein
the first wireless communication device is located at a distance where wireless communication based on BLE cannot be performed with the third wireless communication device, and
the second wireless communication device is located at a distance where wireless communication based on BLE can be performed with the third wireless communication device.

14. The wireless communication system of claim 13, wherein
the second wireless communication device is determined from among the plurality of wireless communication devices based on location of the third wireless communication device.

15. A wireless communication device that operates to manage a wireless multi-hop network, among a plurality of wireless communication devices that constitute the wireless multi-hop network, the device comprising:
a processor configured to request a first wireless communication device among the plurality of wireless communication devices, to perform proxy of authentication of a second wireless communication device to be allowed to newly join the wireless multi-hop network,
wherein
the first wireless communication device is configured to perform authentication communication with the second wireless communication device for performing authentication of the second wireless communication device, and
while the authentication communication is being performed, the wireless communication device and the first wireless communication device are configured not to perform communication related to the authentication.

16. A wireless communication device that constitutes a wireless multi-hop network, the device comprising:
a processor configured to perform authentication communication with a second wireless communication device to be allowed to newly join the wireless multi-hop network, for performing authentication of the second wireless communication device, based on a request from the first wireless communication device that operates to manage the wireless multi-hop network,
wherein
while the authentication communication is being performed, the wireless communication device and the first wireless communication device are configured not to perform communication related to the authentication.

17. A method executed by a wireless communication system comprising a plurality of wireless communication devices that constitute a wireless multi-hop network, the method comprising:
requesting, by a first wireless communication device that operates to manage the wireless multi-hop network among the plurality of wireless communication devices, a second wireless communication device, that is different from the first wireless communication device, to perform proxy of authentication of the third wireless communication device to be allowed to newly join the wireless multi-hop network; and
performing, by the second wireless communication device, authentication communication with the third wireless communication device for performing the authentication of the third wireless communication device, wherein
while the authentication communication is being performed, the first wireless communication device and the second wireless communication device do not perform communication related to the authentication.

18. A method executed by a wireless communication device that operates to manage a wireless multi-hop network among a plurality of wireless communication devices that constitute the wireless multi-hop network, the method comprising:
requesting a first wireless communication device among the plurality of wireless communication devices to perform proxy of authentication of the second wireless communication device to be allowed to newly join the wireless multi-hop network,
wherein
the first wireless communication device performs authentication communication with the second wireless communication device for performing authentication of the second wireless communication device, and
while the authentication communication is being performed, the wireless communication device and the first wireless communication device do not perform communication related to the authentication.

19. A method executed by a wireless communication device that constitutes a wireless multi-hop network, the method comprising:
performing, based on a request from a first wireless communication device that operates to manage the wireless multi-hop network, authentication communication with a second wireless communication device, for performing authentication of the second wireless communication device to be allowed to newly join the wireless multi-hop network, and
while the authentication communication is being performed, the wireless communication device and the first wireless communication device do not perform communication related to the authentication.
